(19) United States
(12) Patent Application Publication
(10) Pub. No.: US 2005/0185743 A1
(43) Pub. Date: Aug. 25, 2005

(54) Apparatus for burst and timing synchronization in high-rate indoor wireless communication

(75) Inventor: Wenzhen Li, Singapore (SG)

Correspondence Address: QUARLES & BRADY LLP, 411 E. WISCONSIN AVENUE, SUITE 2040, MILWAUKEE, WI, 53202-4497, US

(73) Assignee: Oki Techno Centre (Singapore) Pte Ltd

(21) Appl. No.: 11/034,571

(22) Filed: Jan. 13, 2005

(30) Foreign Application Priority Data
Jan. 14, 2004 (SG) 200400293-7

(51) Int. Cl. H04B 1/10

(52) U.S. Cl. 375/350

(57) ABSTRACT

An apparatus provides burst and timing synchronization of an input signal used for high-rate indoor wireless communication, comprising. A burst synchronizer (20) is arranged to detect the onset of a burst of the input signal and provides an onset indicator. A frequency offset corrector (12) is arranged to correct the frequency offset between adjacent preamble sequences of frames within the burst of the input signal based on the onset indicator and provides a frequency offset corrected signal. A timing synchronizer (30) is arranged to detect the timing of first symbol of first frame of the frequency offset corrected signal, and provides a timing indicator. An equalizer (40) is arranged to remove inter-symbol interference from the frequency offset corrected signal based on the timing indicator.

### FIELD OF THE INVENTION

The present invention relates to an apparatus for burst and timing synchronization in a receiver in wireless burst communication, especially in high-rate indoor wireless communication, such as high-rate bluetooth communication. The invention particularly relates to incorporating burst and timing synchronization, frequency offset correction and channel estimation in a low cost, and low powerconsumption receiver.

### BACKGROUND OF THE INVENTION

Most of the WLAN (Wireless Local Area Network) and WPAN (Wireless Personal Area Network) systems that use a channel hopping methodology require a transmitter to send a synchronizing sequence, or a preamble sequence ahead of any data to permit a receiver to locate and synchronize itself with the transmitter. All digital sequence detectors used in a receiver require a long time to detect the synchronizing sequence or a particular digital sequence in the preamble as an indication of synchronization. There are two popular categories of techniques used to extract frame synchronization information which represents the timing of the first frame in the received signal.

The first category of techniques is used in time division multiple access (TDMA) systems. In TDMA systems, at the transmitter, users are allocated separate time slots within the same frequency bandwidth. Each of the time slots is accompanied by a synchronization sequence which is known by the receiver and enables the receiver to achieve synchronization with the transmitter. Usually, the synchronization sequence is chosen so that it exhibits a zero autocorrelation characteristic. More specifically, if such a synchronization sequence is correlated with itself, only when the sequences being correlated are aligned, does the correlation result in a pulse output. At other times, the correlation output is zero or nearly zero. In “Symbol and frame synchronization in a TDMA system“, U.S. Pat. No. 5,408,504, Apr. 18, 1995, Ostman utilized this characteristic to obtain the symbol and frame synchronization.

Moreover, it is well known by those skilled in the art that a synchronization sequence exhibiting a zero autocorrelation characteristic allows an impulse response of a channel to be estimated and enables timing synchronization. Therefore, when the received signal is over-sampled at above four times, frame synchronization, channel estimation and accurate timing synchronization can be accomplished simultaneously. Timing synchronization is the accurate timing of the phase of a symbol. In particular it can be the accurate timing of the phase of the first symbol. Frame synchronization is the correct timing of the start of one frame.

Although the frame synchronization scheme used in a TDMA system is efficient, it requires a special synchronization sequence which has good autocorrelation characteristics, i.e. the CAZAC sequence. The CAZAC sequence is a periodic sequence with optimal properties for channel estimation and fast start-up equalization (as described in “IBM Journal of research and development”, vol 27, no.5, pp.426-431, September 1983). The synchronization sequence is stored in the Sync Word of a data frame according to this frame synchronization scheme. The pattern of a TDMA system packet places the Sync Word in the middle of the frame. Thus, in order to utilize this synchronization sequence to accomplish frequency offset estimation or adaptive equalization training, a large memory is needed to pre-store all of the received samples. This will be impossible in a low cost and low power consumption implementation.

Another category of frame synchronization techniques is also well known in the prior art. Examples of these techniques are described in “Optimum Frame Synchronization” by James L. Massey, IRRR Trans. on Comm., Vol. 20, April 1972, p.p. 115-119, and “Optimum Frame Synchronization for Asynchronous Packet Transmission” by R. Mehlan and H. Meyr, ICC 1993 in Geneva, Vol. 2/3, p.p. 826-830. These techniques are generally used by systems where no preamble sequence is needed to perform the system training before demodulation. Therefore, the frame synchronization is performed after the received signal is demodulated and payload information thereof is correctly recovered. Then, the demodulated sequence is correlated using a known synchronization sequence (which can be easily implemented by binary summation). When the demodulated sequence is aligned with the synchronization sequence, a large correlation output occurs. Thus direct amplitude detection can be used to accomplish the frame synchronization. This scheme has two beneficial features: first, it is very simple since the system does not need any preamble sequences to perform system training before demodulation; second, it does not require much from the synchronization sequence, namely, it does not require a special sequence with good autocorrelation characteristic as in TDMA systems.

However, this frame synchronization method has the disadvantage that the clock, carrier and phase synchronization must be implemented before the actual frame synchronization in order to demodulate the received signal. Performing carrier and phase synchronization without frame synchronization, and thus without knowledge of the data sequence, is only possible by utilizing Non-Data-Aided (NDA) methods. These NDA methods usually have much higher complexity and poorer performance than the data-aided methods. Therefore, they are not ideal solutions for a low cost and low power consumption receiver, especially when preamble sequences have already been included in the packet and occupy transmission bandwidth.

There are many other prior art methods for a receiver to obtain frame, carrier frequency and timing synchronization by using a synchronization or preamble sequence. For example, “Method for frame synchronization”, U.S. Pat. No. 6,002,729, Dec. 14, 1999, by Kurt Schmidt, proposes a method to implement the frame and timing synchronization by using maximum likelihood theory. However, this method is calculation-intensive. Moreover, in order to eliminate the effects of timing, frequency and phase error on each other's estimations, a series of approximations are performed according to this method, which substantially decreases the accuracy of the estimates of timing and carrier frequency and phase.

In “Method and apparatus for combined timing recovery, frame synchronization and frequency offset correction in a receiver“, U.S. Pat. No. 6,058,150, May 2, 2000, by Biswa R. Ghosh, proposes a method to accomplish the timing recovery, frame synchronization and frequency offset correction simultaneously. This invention avoids the disadvantages caused by performing the three tasks in sequence. However, this method is efficient only when used with FSK modulation based on T/8 sampling rate.

In “Method and apparatus for frame synchronization mobile OFDM data communication”, U.S. Pat. No. 5,444,697, Aug.22, 1995, by Leung et. al. proposes a method to implement the timing and frame synchronization for OFDM systems in an ALOHA environment. This method accomplishes its task in three phases: phase I, power estimation to detect the onset of the preamble sequence; phase II, coarse synchronization; and phase III, fine synchronization. However, in this invention, the detection of the onset of the preamble sequence using amplitude detection is not robust over a large range of SNR, which increases the probability of a false alarm or missed detection. Moreover, its fine synchronization is only suitable for OFDM systems.

To provide a low cost and low power consumption implementation for high-rate indoor wireless communication, the following requirements should be met. An ideal synchronization method should be accurate and utilize as little memory as possible. Moreover, it should also be robust to channel impairments (e.g., a large range of SNR and frequency selective fading) and system impairments (e.g., frequency offset). Unfortunately, the methods well known in the prior art do not provide an adequate solution.

### SUMMARY OF THE INVENTION

The object of the present invention is to provide a method and apparatus of burst and timing synchronization with improved accuracy, low cost and low power consumption.

Data is transmitted burst-by-burst in high-rate wireless communication systems. Each burst contains several frames, if a fast and accurate burst synchronization, which represents the onset of data transmission, is accomplished first, then it is possible to implement the inexpensive data-aided timing synchronization which indicates the timing of the first symbol of the first frame, carrier recovery which offsets the carrier frequency error, and channel equalizer training used to eliminate the inter-symbols interference (ISI) existing in the adjacent frames.

More generally, the invention is an apparatus arranged for burst and timing synchronization of an input signal in high-rate indoor wireless communication. The apparatus includes a means arranged to detect an onset of a burst of the input signal to provide an onset indicator; a frequency offset corrector arranged to correct a frequency offset of the received signal within the burst of the input signal based on the onset indicator, to provide a frequency offset corrected signal; and a means arranged to detect timing of first symbol of a first frame of the frequency offset corrected signal, to provide a timing indicator.

The invention also includes a digital receiver. The digital receiver includes a means arranged to convert a received signal into a baseband digital signal; a means arranged to detect an onset of a burst of the input signal to provide an onset indicator; a frequency offset corrector arranged to correct a frequency offset of the received signal within the burst of the input signal based on the onset indicator, to provide a frequency offset corrected signal; a means arranged to detect timing of first symbol of first frame of the frequency offset corrected signal, to provide a timing indicator; an equalizer arranged to remove inter-symbol interference from the frequency offset corrected signal based on the timing indicator; and a differential demodulator, integrated with the equalizer, arranged to differential demodulate the output from the equalizer based on the timing indicator.

The invention also includes a method of burst and timing synchronization of an input signal in high-rate indoor wireless communication. The method includes the steps of detecting onset of a burst of the input signal to provide an onset indicator; correcting a frequency offset of the received signal within the burst of the input signal based on the onset indicator, to provide a frequency offset corrected signal; and detecting timing of first symbol of first frame of the frequency offset corrected signal, to provide a timing indicator.

The present invention can also be extended to a pure ALOHA environment. This is because in a pure ALOHA environment the receiver does not know when a data frame will be transmitted and a data frame may be transmitted at any random time. By using the method and apparatus of burst and timing synchronization of the present invention, the timing of the data in the receiver can be synchronized with that in the transmitter.

### BRIEF DESCRIPTION OF THE DRAWINGS

FIG. 1 illustrates the format of a packet transmitted in the high-rate indoor communication;

FIG. 2 is a schematic diagram illustrating the structure of a base-band receiver of the present invention;

FIG. 3 is a schematic diagram illustrating the detailed circuit of a burst synchronizer in the receiver shown in FIG. 2;

FIG. 4 is a schematic diagram illustrating the detailed circuit of a complex correlator used in the burst synchronizer and timing synchronizer shown in FIG. 2;

FIG. 5 is a schematic diagram illustrating the detailed circuit of the timing synchronizer shown in FIG. 2;

FIG. 6 is a schematic diagram illustrating the detailed circuit of integrating a LMS-DFE equalizer and differential demodulator shown in FIG. 2;

FIG. 7 illustrates the correlation output of the correlator of the burst synchronizer in the presence of frequency offset;

FIG. 8 illustrates the correlation output of the correlator of the timing synchronizer after the correction of frequency offset;

FIG. 9 is a diagram illustrating burst and timing synchronization based on the correlation output; and

FIG. 10 illustrates the probability of the burst detection error versus SNR of the present invention.

### DETAILED DESCRIPTION OF THE PREFERRED EMBODIMENT OF THE INVENTION

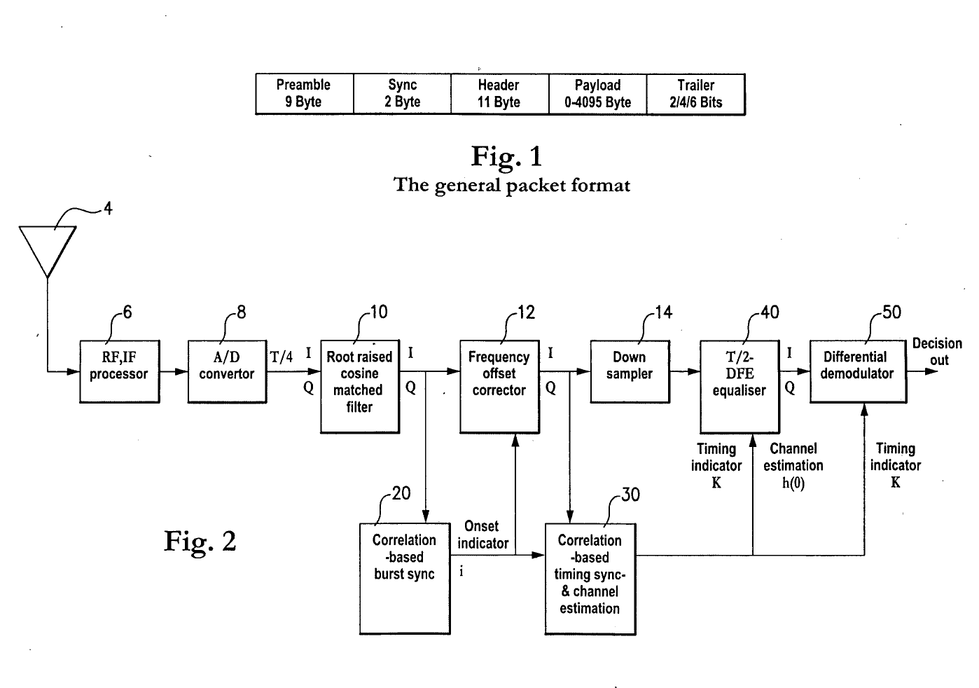

The format of a packet transmitted in the high-rate indoor communication, such as bluetooth, is shown in FIG. 1. The packet consists of five fields: preamble, sync word, header, payload and trailer. Except for the trailer field which is shown in units of bits, the remaining four fields, i.e., preamble sequence, sync word, header, and payload are all shown in bytes. The preamble is a pseudonoise sequence, with the length of 9 bytes obtained by repeating the following 1-byte sequence nine times: {0 0 0 0 1 1 1 1}. The sync word is a 2-byte sequence: {0 0 0 0 0 0 1 0 0 1 1 1 0 1 0 1}. The header contains all address information as well as other control information. The payload contains user information, which is further subdivided into segments if large. The preamble, sync word and the header are modulated by using DBPSK. The modulation format of the payload is indicated in the header and can be DBPSK, DQPSK, or 8-DPSK. The trailer is modulated by the same format as the payload. In the absence of a payload, the trailer is modulated by the same format as the header (i.e., by DBPSK).

Moreover, since the receiver suffers from frequency error, timing error and ISI fading, the receiver architecture should be developed to meet the performance requirement of the specification. At the same time, minimum complexity and cost are design goals.

In the present invention, since the adopted fractional-spaced complex DFE is robust to timing error, and able to compensate for small carrier frequency error, the method and apparatus for burst and timing synchronization of the present invention mainly concerns the accurate initial estimation of the burst synchronization, the timing synchronization and the carrier frequency. The frequency carrier and timing tracking circuits are beyond the scope of the current invention.

FIG. 2 is a simplified block diagram of a receiver for high-rate wireless indoor communication that is constructed and operated in accordance with the present invention.

As shown in FIG. 2, an antenna 4 receives a 2.4 GHz modulated RF signal which is transmitted in an indoor frequency selective channel having a bandwidth equal to 4 MHz. The received RF signal is processed by RF and IF (intermediate frequency) modules 6 and is down-converted to the baseband frequency. Then, an A/D converter 8 with sampling rate of 4× the symbol rate is used to sample the baseband signal with a T/4 sampling period and digitized samples, I and Q, are obtained. The digitized samples pass through a receiver matched filter 10. The receiver matched filter is a root raised cosine impulse response FIR filter, and the roll-off factor is 0.4, which has the same property as the pulse-shaping filter in the transmitter. After the matched filter, a correlation-based burst synchronizer 20 is used to detect the onset of a burst and thus the onset of the transmission of data is detected.

It can be seen that there are 9 preamble sequences and one Sync Word before the payload, and neither the preamble sequences nor the Sync Word has the same autocorrelation characteristics as the CAZAC sequence in a TDMA system. That is to say, even if the received sequence is not aligned, a large correlation output pulse (i.e., side lobe) may result. Therefore, it is impossible to obtain accurate burst synchronization by the method of pulse detection as disclosed in U.S. Pat. No. 5,408,504. This is because many pulses may occur in the correlation output. Even by using modified pulse detection methods, such as the amplitude detection with a threshold, or the peak detection with a specific window, this problem cannot be solved effectively. The modified method such as the amplitude detection with a threshold causes a high probability of false alarm, especially in a frequency selective fading channel and in the presence of large frequency offset. Furthermore, for the modified method of peak detection with a specific window, it is very difficult to determine the start and end points of the sliding window. Therefore, the present invention applies threshold and slope detection to determine the onset timing of the burst, the details of which are explained as follows.

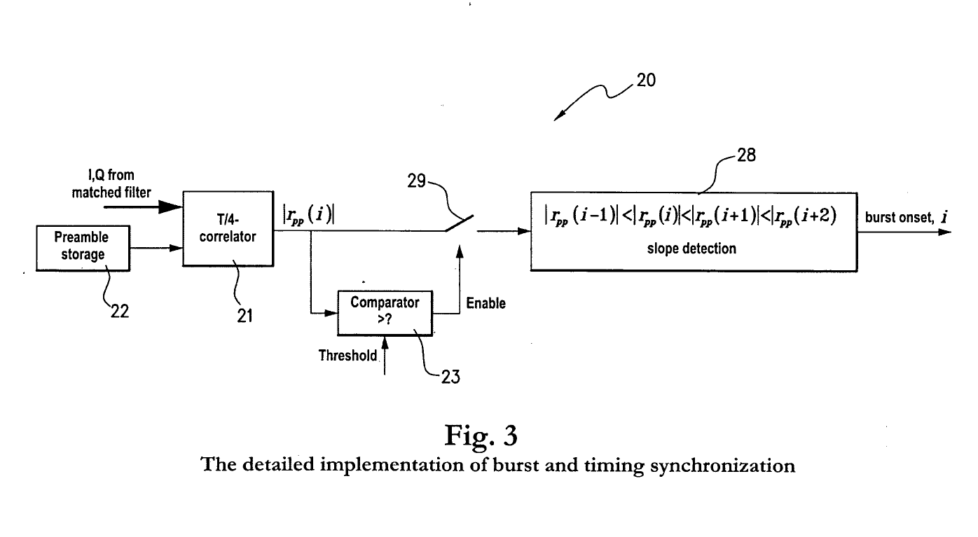

The circuit for the burst synchronizer is shown in FIG. 3. The synchronizer 20 includes a preamble storage 22 for storing a reference preamble sequence, a complex T/4-spaced correlator 21 for correlating the samples I and Q from the matched filter 10 with the preamble sequence stored in the preamble storage 22 to output a correlation output |rₚₚ(i)| with a 4× symbol rate, a comparator 23 for comparing the correlation output with a predetermined threshold and for enabling the following slope detection by closing a switch 29 if the correlation output is larger than the threshold, and a slope detector 28 for finding the onset timing of a burst with slope detection and outputting a burst onset indicator i.

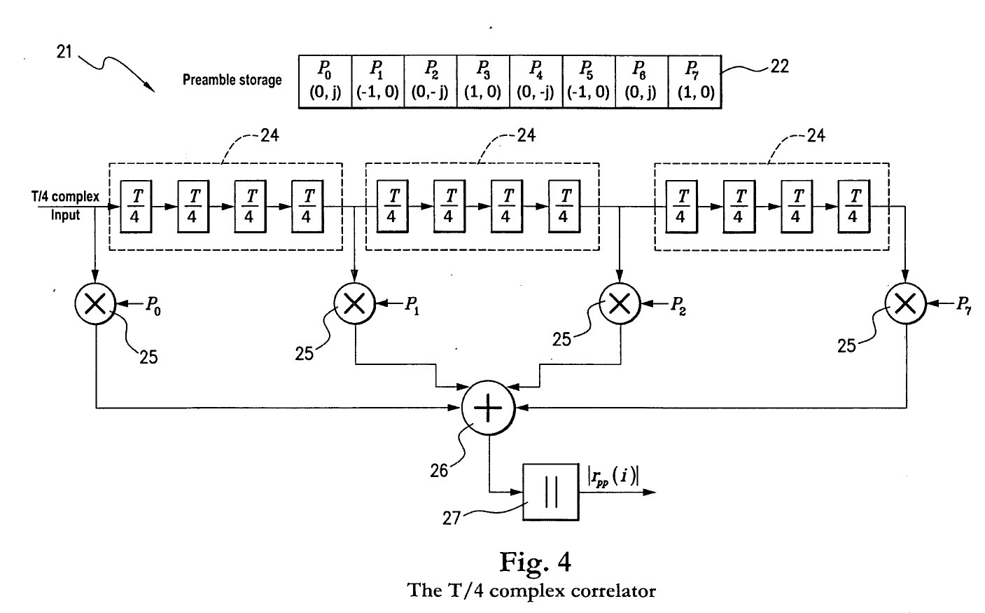

Now, with additional reference to FIG. 4, which illustrates a circuit for the complex correlator 21, the operation of the burst synchronizer 20 is explained. As shown in FIG. 4, the complex correlator 21 comprises complex symbol delay units 24 (each including four T/4-sample delay units) for delaying the input samples I and Q by one symbol duration T; multipliers 25 for multiplying the input samples I, Q and the output of the delay units with each bit of the preamble sequence stored in the preamble storage 22, {(0, j), (−1, 0), (0, −j), (1, 0), (0, −j), (−1, 0), (0, j), (1, 0)}; an adder 26 for summing all the results of the multiplications; and a module unit 27 to obtain the module of the sum from the adder 26.

After the matched filter 10, the preamble signal of the input samples I and Q can be represented as:

$$r ( t ) = {ⅇ}^{- j ( {2}^{π} Δ {f}_{c} t + φ )} {\sum }_{k = - ∞}^{∞} {p}_{k} h ( t - k T - {}^{ɛ} T ) + n ( t ) \qquad ( 1 )$$

where {pₖ} is a π/2-DBPSK modulated preamble sequence, as shown in FIG. 4; h(t) is the equivalent channel response pulse, which includes the effects of transmitter shaping filter, receiver matched filter, and the frequency selective fading; n(t) is the background noise, Δf_{c}, φ and ε are respectively carrier frequency offset, carrier phase, and normalized time error, which are all unknown. Since the matched filter outputs the samples with sampling period T/4, the receiver detects the presence of the preamble by correlating the conjugate of the preamble sequence, whose length is 8 bits, with the preamble signal of the input samples, r(iT+4kTₛ), where Tₛ is the sampling period. The output of the adder 26 can be represented as:

$${r}_{pp} ( i ) = {\sum }_{k = 0}^{7} r ( i {T}_{s} + 4 k {T}_{s} ) {p}_{k}^{*} \qquad ( 2 )$$

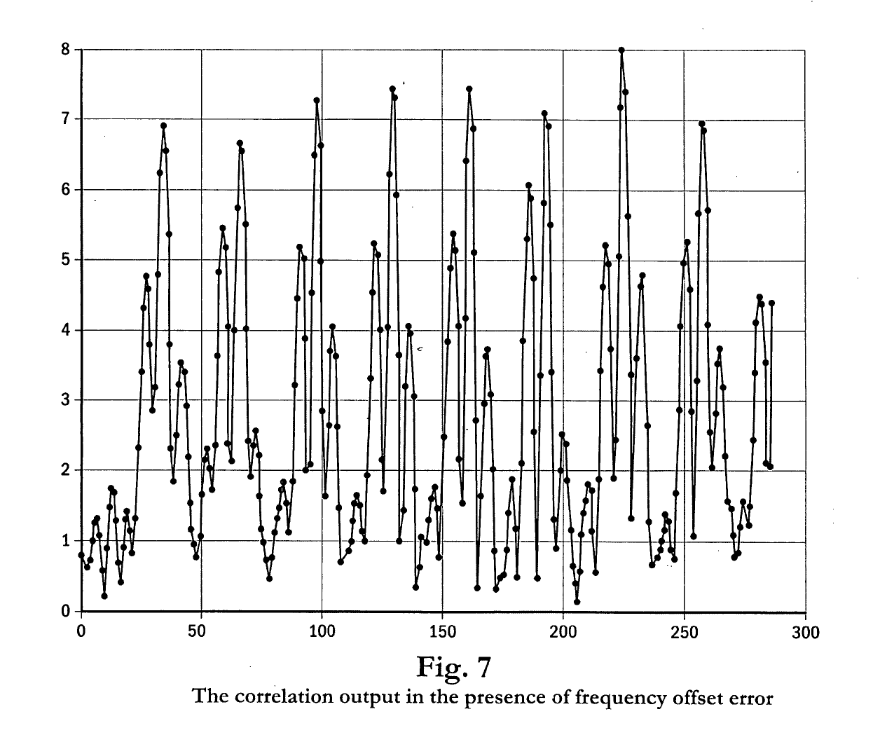

After the module unit 27, the correlator 21 outputs a large magnitude of the sum, i.e., |rₚₚ(i)|. The |rₚₚ(i)| in the presence of channel and system impairments is shown in FIG. 7. With the known reference preamble sequence and π/2-DBPSK modulation, the output of correlation presents a unique pattern, which has the following features: first, once the preamble is aligned, the peak amplitude occurs, and the main lobe of |rₚₚ(i)| is presented. Besides the main lobe, when the reference preamble sequence and the input samples are apart by two symbols, the side lobes are presented. Therefore, the evident slopes of these lobes can be observed. These features can be skillfully utilized to detect the onset of the burst and initiates the carrier frequency offset estimate and timing synchronization.

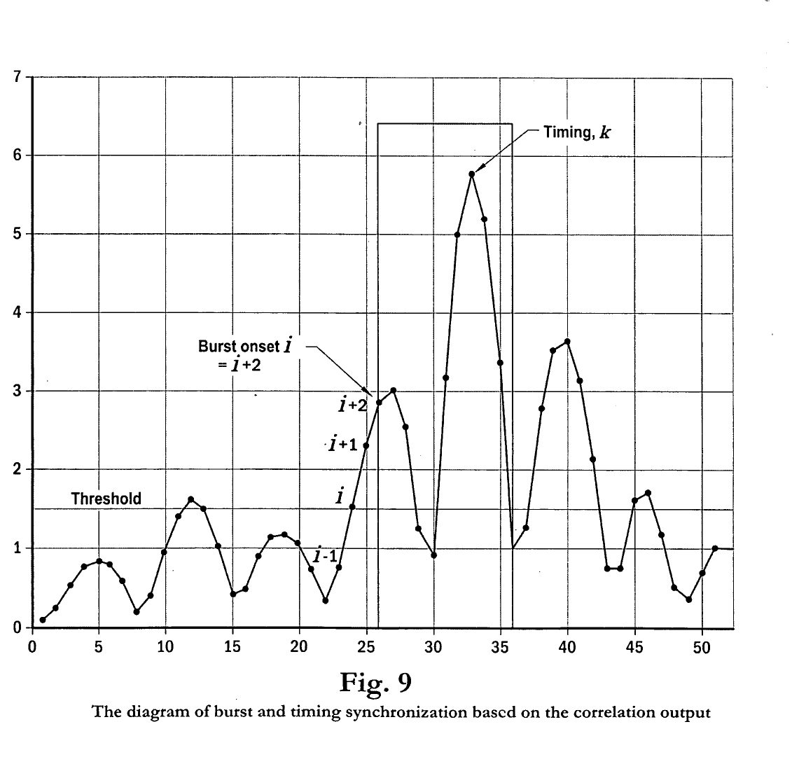

FIG. 9 shows the efficient burst detection of this invention. Once
rₚₚ(i−b 1)<rₚₚ(i)<rₚₚ(i+1)<rₚₚ(i+2) (3)
and
rₚₚ(i)>Threshold (4)
the onset of the burst is supposed to be found, i.e., the timing i+2. Then, the burst synchronizer 20 outputs the onset indicator i+2. This proposal has the following advantage: compared to the conventional schemes, which only use the amplitude or slope detection, the combination detection of amplitude and slope detection in the present invention substantially decreases the probability of false alarms and mis-detection and the probability of the overall error detection can be lowered to 0.5%. Here mis-detection refers to the problem whereby during the length of the sliding window, the timing is not found, and so a default value is output. This problem is generally caused by the received signal being so small that it is buried in noise.

There are several reasons for combining the amplitude and slope detection. If only amplitude detection is performed, the false alarm and mis-detection probability will be very high since the peak amplitude of the output signal may change within a large range due to the wide range of the SNR, channel fading, and frequency offset. If only slope detection is performed, due to the symbol repetition in a preamble sequence, false alarms may occur frequently.

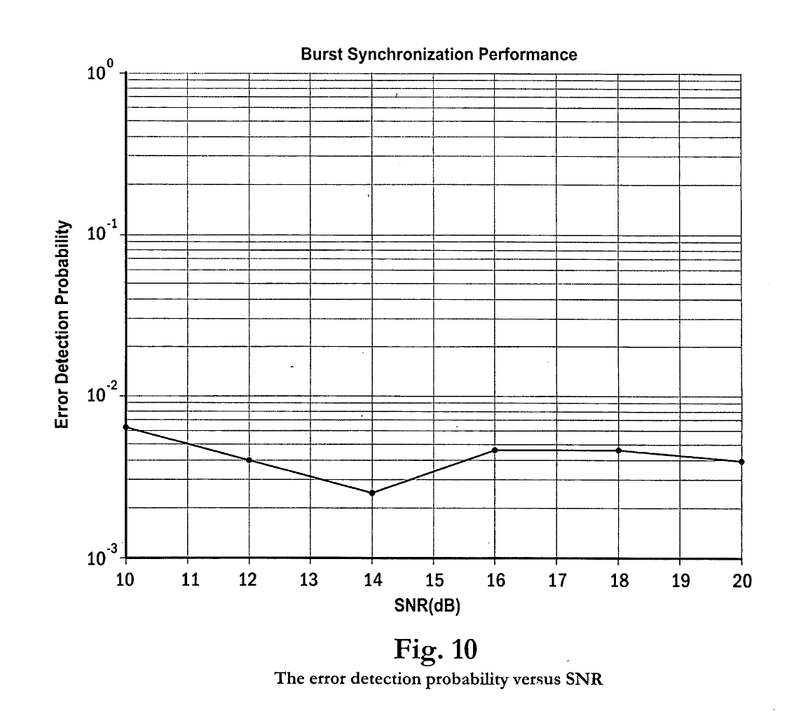

The probability of burst error detection versus SNR for the present invention in the presence of channel impairments, such as frequency selective fading and noise, and system impairments, such as frequency offset, are shown in FIG. 10. It can be seen that this method is quite robust to these impairments, the accuracy of the first preamble detection is up to 95.5% over a large range of SNR. Of course, this good performance is obtained by optimizing the setting of the threshold.

A key for the setting of the threshold lies in that once the preamble is encountered in the burst synchronizer, there is one side lobe and one main lobe exiting from the correlation output, both of which are higher than the level of the output noise. Therefore, a lower threshold is set, which is around the maximum of the noise level. With this setting, the side lobe is detected first. Even if the side lobe is missed due to system impairments, the burst onset information can be extracted from the following main lobe, thus the detection accuracy increases substantially. Another advantage for setting a lower threshold is that a lower threshold also decreases the extra storage in the implementation of timing synchronization. This will be addressed in detail in the following description.

Returning to FIG. 2, after the burst onset is detected, the receiver then estimates the initial synchronization parameters, namely, the symbol timing, which is the timing of the first symbol of the first packet, and the carrier frequency offset existing between the preamble sequences of the input signal. The estimation starts from the onset timing of the burst, which substantially increases the accuracy of the estimation, and dramatically decreases the time and memory consumed.

However, the sequence of performing the tasks of timing synchronization and frequency offset correction must be addressed carefully. If timing synchronization is performed first, it suffers from frequency offsets existing in the samples. Similarly, if frequency offset correction is performed first, it must be done independently of the symbol timing, and its accuracy is reduced.

In the present invention, the frequency offset error corrector 12 estimates the frequency offset error correction frequency offset error correction by a modified method proposed for OFDM system, “Robust frequency and timing synchronization for OFDM”, IEEE Trans. Commun., Vol. 45, No.12, pp1613-1621, December 1997, by T. M. Schmidl and D. C. Cox. By utilizing the repetition of the preamble sequence, the frequency offset can be estimated and corrected by measuring the average phase difference of two adjacent preamble sequences of the input signal. This method allows a large range of carrier frequency offset to be corrected. Moreover, due to the repetition of the preamble and the high sampling rate (4× symbol rate), the frequency offset correction is insensitive to the starting point of the following channel estimation. This is to say, the frequency offset correction is quite robust to the timing error and can be performed before the timing synchronization.

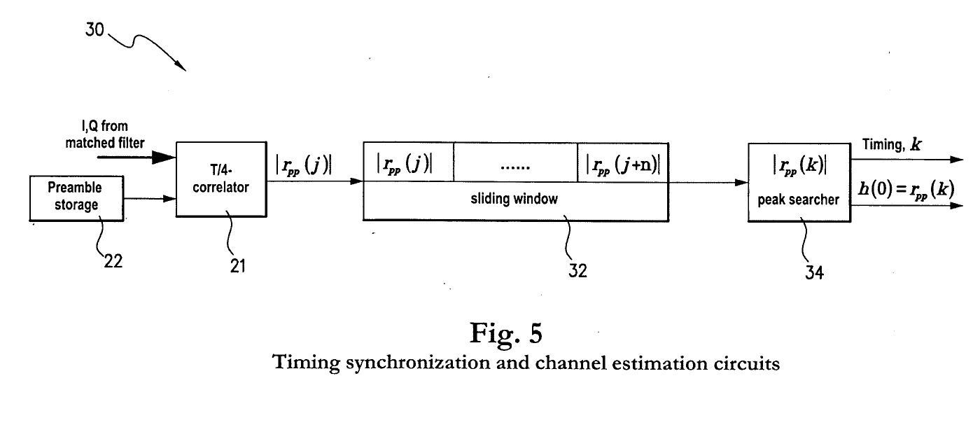

After the frequency error correction of the frequency error corrector 12, the timing synchronization and channel estimation 30 based on a complex correlation can be implemented. The detailed circuit of the timing synchronizer is shown in FIG. 5.

As shown in FIG. 5, the timing synchronizer includes a preamble storage 22 for storing a reference preamble sequence which is the same as that used in the burst synchronizer 20; a complex T/4-spaced correlator 21 for correlating the input samples I and Q with the reference preamble sequence from the preamble storage, to provide correlation output |rₚₚ(j)|; a sliding window 32 for determining the searching length from |rₚₚ(j)| to |rₚₚ(j+n)|, where n is the length of the sliding window; a peak searcher 34 for searching for the largest correlation output within the sliding window, |rₚₚ(k)|, to provide a timing indicator k, indicating the timing of the first symbol of the first preamble of the input signal.

The correlator 21 applied in the timing synchronizer 30 is the same as the one in th burst synchronizer, whose detailed circuit was shown in FIG. 4. Instead of using the Sync Word as the reference input of the complex correlator, the preamble sequence is applied, just as in the burst synchronizer 20, which substantially decreases the memory space needed. After the correlation, a certain number of the correlation output samples |rₚₚ(j)|˜|rₚₚ(j+n)| pass through the sliding window and peak searcher 32 and 34. As shown in FIG. 9, the starting point of the sliding window, is the onset timing i of the burst which is detected by the burst synchronizer 20. The largest length of the sliding window, n, is selected to be shorter than the length of one preamble, which decreases the probability of error detection. In fact, the length n is a tradeoff between the detection performance and the extra storage. To illustrate this tradeoff, for a sliding window with the largest length n, if the timing is found from the kth symbol in the sliding window then the input signal from k to the end of sliding window is useful and should be stored. Therefore, the storage should be n-k symbols. Here the extra storage refers to the memory units excluding the delay units 24 used in correlator 21. It is determined by the distance between the timing k of the largest correlation output |rₚₚ(k)| and the end point of the window.

As mentioned above, setting a lower threshold decreases the extra storage in the implementation of timing synchronization. The reason for this is that the extra storage is determined by n-k. Using a lower threshold results in the detection of the peak of the side lobes. Thus, the peak of main lobe, k generally is in the middle of sliding window. With a higher threshold, which detects only the peak of main lobe, the peak of main lobe, k, is located in the beginning of the sliding window and therefore large n-k results (extra storage is required).

The process of the peak searcher 34 is explained as follows: beginning at the starting point of the sliding window, each of the correlation outputs |rₚₚ(j)| in the sliding window is compared with the correlation output |rₚₚ(k)| stored in the extra memory. If the correlation output in the sliding window is larger, the amplitude value, |rₚₚ(k)|, the corresponding complex value, rₚₚ(k), and index, k, in the extra memory are updated. The above steps continue until the end of the sliding window and then the peak searcher 34 outputs the timing indicator k which is the timing of the largest correlation output within the sliding window.

The timing synchronization according to the present invention achieves the timing synchronization and channel estimate at the same time as follows. After the frequency offset correction, the received signal can be represented as,

$$r ( t ) = {ⅇ}^{- j φ} {\sum }_{k = - ∞}^{∞} {p}_{k} h ( t - k T - ɛ T ) + n ( t ) \qquad ( 5 )$$

Thus, the correlation result is expressed as,

$$\begin{matrix}{r}_{pp} ( i ) = {\sum }_{k = 0}^{7} r ( i {T}_{s} + 4 k {T}_{s} ) {p}_{k}^{*} \\ = {ⅇ}^{- j φ} {\sum }_{k = 0}^{7} {p}_{k}^{*} [ {\sum }_{m = - ∞}^{∞} {p}_{m} h ( i {T}_{s} + 4 k {T}_{s} - m T - {}^{ɛ} T ) + \\ n ( i {T}_{s} + 4 k {T}_{s} ) ] \\ = {ⅇ}^{- j φ} {\sum }_{k = 0}^{7} {p}_{k}^{*} [ {\sum }_{{m}^{′} = - ∞}^{∞} {p}_{m} h ( i {T}_{s} + 4 k {T}_{s} - 4 {m}^{′} {T}_{s} ) + {n}^{′} ( i ) ]\end{matrix} \qquad ( 6 )$$

When the reference preamble sequence is aligned with the input sample, the peak amplitude of the correlation is obtained, namely, the exact timing k of the first symbol of the first preamble is obtain, and then m′=k. Thus, we obtain,

$${r}_{pp} ( i ) = {ⅇ}^{- j φ} {\sum }_{k = 0}^{7} {p}_{k}^{*} {p}_{k} h ( i ) + {n}^{′} ( i ) \qquad ( 7 )$$

namely,

$${r}_{pp} ( 0 ) = {ⅇ}^{- j φ} h ( 0 ) {\sum }_{k = 0}^{7} {\vert {p}_{k} \vert}^{2} + {n}^{′} ( 0 ) \qquad ( 8 )$$

Therefore, the first tap of CIR, h(0), can be estimated when the effect of the noise is negligible.

Here, the effect of carrier phase, e^{-jφ}, is included in the channel estimation, which will be

$$h ( 0 ) \approx \frac{{r}_{pp} ( 0 )}{{ⅇ}^{- j φ} {\sum }_{k = 0}^{7} {\vert {p}_{k} \vert}^{2}} \approx \frac{{r}_{pp} ( 0 )}{8} \qquad ( 9 )$$

removed by the following differential demodulator 50.

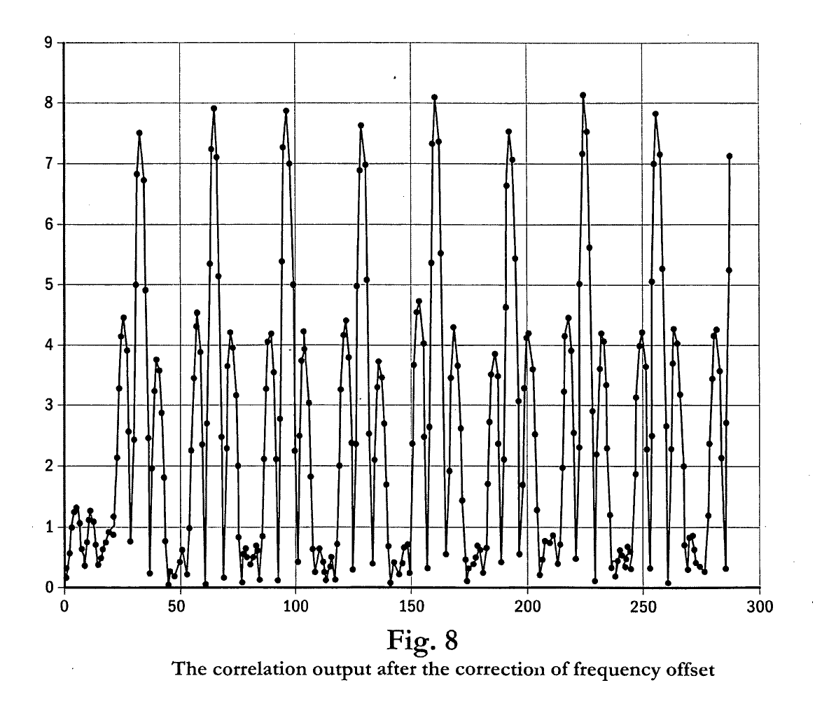

The correlation output from the timing synchronizer 30 after the frequency offset correction is shown in FIG. 8. Comparing the correlation outputs from the burst synchronizer in the presence of the frequency offset with those from the timing synchronizer after the frequency offset correction, as shown in FIG. 7 and FIG. 8, it can be seen that the accurate timing is quite sensitive to the frequency offset, which may cause one or two samples difference, equivalent to a timing error of T/4 to T/2. Therefore, frequency offset correction is performed first, followed by the timing synchronization and channel estimation, as shown in FIG. 2. This arrangement results in improved timing synchronization performance.

After the packet timing and frequency synchronization are achieved, the baseband receiver of FIG. 2 performs equalization and differential demodulation. Equalization is essential when the delay spread exceeds one third of the symbol period over a frequency selective multipath fading channel. In a typical indoor environment, the delay spread is in the range of 20-50 ns, and average delay spread is 25 ns. Therefore, in the present wireless indoor system with high data rate, the delay spread is up to one symbol period, hence serious intersymbol interference (ISI) may be caused. Therefore, equalization is necessary to combat the ISI.

The input samples I and Q are fed to the T/2-DFE equalizer 40, which combats the ISI existing in the adjacent preamble sequences of the input signal caused by the frequency selective multi-path fading channel, and the differential demodulator 50, which demodulates the input samples I and Q to extract the payload information therefrom.

Before being fed to the T/2-DFE equalizer 40, the input samples I and Q pass through a down-sampler 14 as shown in FIG. 2. The down-sampler 14 down-samples the over-sampled 4× symbol rate signal to a 2× symbol rate. The down-sampler 14 is between the frequency offset corrector 12 and the T/2-DFE equalizer 46, after the timing synchronization and channel estimation 30.

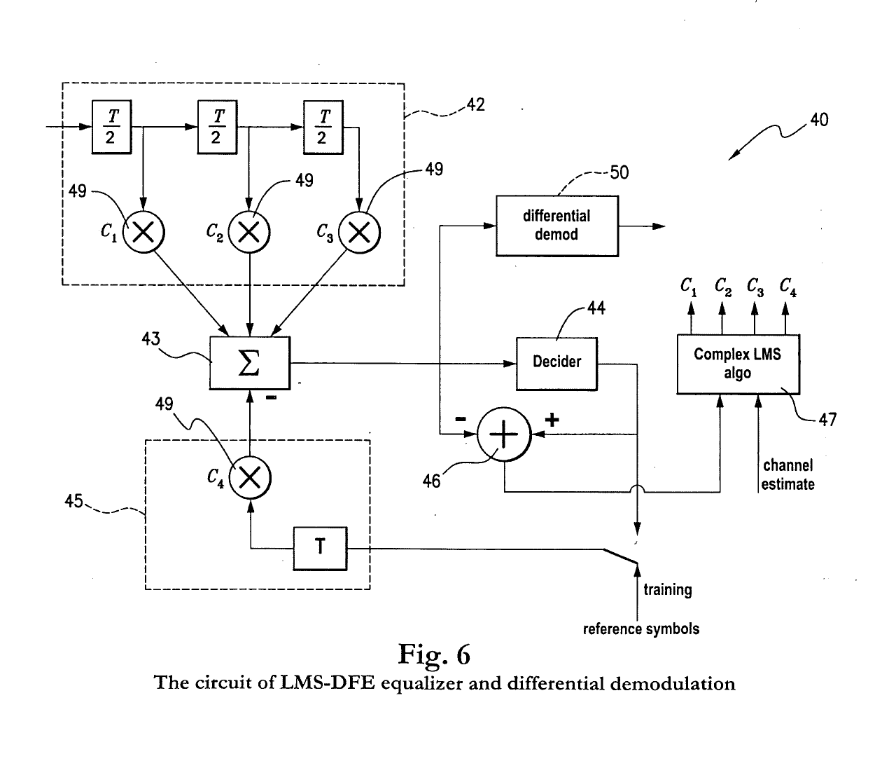

With an effective integration of the equalizer and differential demodulator, the receiver of the present invention is robust to residual frequency error. The timing indicator k is fed to both the equalizer 40 and demodulator 50. For the adaptive equalizer, k starts the training mode. After 88 symbols from k, the demodulator 50 starts the demodulation of header and payload. The detailed circuit of the equalizer 40 and its integration with the differential demodulator 50 is shown in FIG. 6.

In the preferred embodiment of the present invention, the equalizer applied is a complex T/2-spaced DFE equalizer, whose structure is shown in FIG. 6. In FIG. 6, the adaptive equalizer 40 comprises a 3-tap feedforward filter 42 having three T/2 delay units and multipliers 49 for respectively multiplying the outputs from the delay units with filter coefficients C₁, C₂ and C₃; a one-tap feedback filter 45 having a T delay unit and a multiplier 49 for multiplying the output from the delay unit with filter coefficient C₄; a first subtractor 43 for subtracting the multiplication output of the feedback filter 45 from those of the feedforward filter 42 and feedback filter 45; a decider 44 for comparing the difference from the first subtractor 43 with a predetermined value and for outputting the decision value depending on the comparison; a second subtractor 46 for subtracting the input of the decider 44 from its output; and a filter coefficient calculator 47 for calculating the filter coefficients C₁, C₂, C₃ and C₄ according to the difference from the second subtractor 46 and the channel estimation from the timing synchronizer 30. In the preferred embodiment, the differential demodulator 50 is integrated with the equalizer by connecting it to the output of the first subtractor 43. In the preferred embodiment, the taps of the feedforward filter are spaced at half of one symbol period, T/2, which makes the equalizer less sensitive to residual sample timing error. The input signal to the feedforward filter 42 includes received data that has been down-sampled to 2× symbol rate. The feedforward filter 42 compensates for ISI (inter-symbol interference) arising from multipath propagation delays, while the feedback filter 45 serves to remove the ISI due to previous symbols. In this embodiment, the T/2-spaced 3-1 adaptive DFE equalizer is used. It should be appreciated by any skilled readers that other types of equalizers can be used in the receiver of the present invention, e.g. T/4-spaced 5-1 adaptive DFE.

The equalizer 40 is operated in two modes, i.e., training mode and tracking mode. In the training mode, the input signals I and Q are delayed and multiplied with the filter coefficients C₁˜C₃ produced by the filter coefficient calculator 47 in the feedforward filter 42. The feedback filter 45 is fed with reference symbols corresponding to the preamble sequence (9 bytes) or/and Sync Word (2 bytes) as shown in FIG. 1. Then, the reference symbols are delayed and multiplied with the filter coefficient C₄. The first subtractor 43 subtracts the output from the filter 45 from those from the filter 42, and provides the obtained result to the decider 44. The decider compares the result with a threshold which is determined by the modulation/demodulation mode, and outputs the decision value to the subtractor 46. For example, in the DBPSK, the threshold is set to 0, and decider outputs 1 if the result from the first subtractor 43 is above zero, and 0 if it is under zero. Then, the second subtractor 46 subtracts the input to the decider from its output to generate an error signal which is provided to the filter coefficient calculator 47. Note that the error signal is the noise or interference, which follows a Gaussian distribution. In this embodiment, a complex LMS algorithm is used to calculate the coefficients.

For the adaptive DFE equalizer 40, generally two different types of recursive algorithms may be employed. These include gradient algorithm, such as LMS, and recursive least square (RLS) or Kalman-type algorithms. The RLS and Kalman-type algorithms exhibit fast convergence and are insensitive to the channel eigen-value spread. However, these algorithms are complex to implement. The LMS algorithm exhibits slow convergence to optimum coefficient values, and is sensitive to the eigen-value spread of the channels. However, the LMS algorithm is relatively simple to implement in view of this and in accordance with the object of the invention, a complex LMS algorithm is employed by utilizing the channel estimation provided by the timing synchronizer 30, h(0), to help the adaptive DFE to converge quickly.

In the following, the utilization of the channel estimation obtained by the timing synchronizer 30 is described in more detail.

In the conventional method as disclosed by “Delayed decision feedback sequence estimation”, IEEE Trans. On Comm., Vol. 37, No. 5, May 1989, pp428-436, by Alexamdra Duel-Hallen and Chris Heegard, the simplest DFE equalizer can be set up by calculating the coefficients of the filters with causal and stable CIRs. The DFE equalizer involves two filters: a one-tap feedforward filter F(D) and an L-tap feedback filter B(D), functioning to eliminate all ISI and to maximize the signal to noise ratio at the input to the quantizer. The method initializes the equalizer by setting the coefficient of the one-tap feedforward filter to h_{f}(0)=1/h(0), and the coefficients of the L-tap feedback filter to h_{b}(n)=h(n+1)/h(0) (n=0, . . . , L−1), where, h(0), . . . , h(L) are the first tap to the L tap channel impulse responses h(n), with 0≦n≦L. Then, the equalizer converges quickly to the optimum values of the filter coefficients.

In the present invention, since the timing synchronizer 30 only obtains the first tap of the channel impulse response h(0), a zero forcing algorithm is applied to initialize the filters. Given an (L_{f}, L_{b}) DFE (i.e., an equalizer having an L_{f}-tap feedforward filter and L_{b}-tap feedback filter), the calculator 47 is initialized by setting the coefficients of the L_{f}-tap feedforward filter as h_{f}(0)=1/h(0), h_{f}(n)=0 (n=1, . . . , L_{f}) and setting the coefficients of the L_{b}-tap feedback filter as h_{b}(0)=0 (n=1, . . . , L_{b}). In this embodiment where a 3-1 DFE (i.e., an equalizer having 3-tap feedforward filter and 1-tap feedback filter) is applied, the coefficients of the 3-tap feedforward filter are initially set as h_{f}(0)=1/h(0), h_{f}(1)=h_{f}(2)=0, and the coefficient of the 1-tap feedback filter is initially set as h_{b}(0)=0. Then, the calculator 47 converges with the LMS algorithm until the optimum coefficients of the filters are obtained. Experiments prove that with this initialization, the convergence rate of the LMS algorithm increases significantly, and only several or tens of preamble bits are needed to train the adaptive equalizer, instead of hundreds of preamble bits as in the conventional method. In the present invention, another initialization method can be applied for the normalized ISI fading channel, namely, h_{f}(0)=h*(0), h_{f}(n)=0 (n=1, . . . , L_{f}), and h_{b}(n)=0 (n=1, . . . , L_{b}). This initialization method has almost the same convergence property as zero-forcing initialization.

After the coefficients of the filters 42 and 45 are obtained by the calculator 47, the equalizer 40 switches from the training mode to the tracking mode. In the tracking mode, the coefficients of the feedforward filter 42 and the feedback filter 45 are frozen, the feedback filter 45 is fed with the output from the decider 44 and the difference from the first subtractor 43 is input to the differential demodulator 50 for demodulation.

Compared with the conventional differential demodulator whose input is connected with the output of the decider, the integrated structure of the equalizer and demodulator of the present invention is very robust to residual frequency error, which can substantially improve the BER performance in the presence of frequency error. This is because in the process of decision by the decider, the phase of the input signal is rotated randomly to its closest constellation point. However, the residual frequency error in the phase of the input signal always causes the input signal to rotate in a wrong direction. In this case, when the input of the differential demodulator is connected to the output of the decider, it may suffer significant performance degradation.

The method and apparatus for burst and timing synchronization of the present invention has the following advantage:

Firstly, the method and apparatus of the present invention requires less memory space and are faster and more accurate than the conventional methods. Based on the correlation of the received signal and first byte of the known preamble sequence, the onset of a burst, (i.e., the onset of data transmission) is detected by using the combination of amplitude and slope detection. By utilizing the repetition of the first two bytes of the known preamble sequence, the frequency offset is estimated and corrected. After the frequency offset correction, which is robust to timing error, accurate timing synchronization and channel estimation are accomplished simultaneously, in which the timing synchronization is obtained by using the correlation of the received signal and the first byte of the known preamble sequence, which is the same as the burst synchronization. Finally, the integrated structure of the equalizer and differential demodulator eliminates the ISI existing in the adjacent preamble sequences of the received signal, by using the remaining 80 bits of the known preamble sequence and the sync word, and extracts payload information from the received signal. From the above, it can be understood that the memory requirement of the method of the present invention is lower than in the prior art, namely, only 88 bits of the known preamble sequence and sync word are required to be stored in the memory compared with hundreds of bits of known preamble sequences in the prior art. Moreover, in the method of the present invention, onset of each burst of the received signal is detected first, then after the frequency error detection, the timing of the first symbol of the first preamble of each burst is detected, which makes the timing synchronization more accurate and robust to frequency error than the prior art. Since the burst synchronization is implemented for each burst separately, the method and apparatus of the present invention is particularly useful in the application of the asynchronous pure ALOHA system to urban environments where signal fading is a problem.

Secondly, in the present invention, the channel estimation is obtained at the same time as the timing synchronization, which helps the following equalizer to converge more quickly. Further, the differential demodulator is connected to the input of the decider of the equalizer instead of its output as in the conventional method, which improves the BER performance of the receiver of the present invention.

1. An apparatus arranged for burst and timing synchronization of an input signal in high-rate indoor wireless communication, comprising: p1 means arranged to detect an onset of a burst of the input signal to provide an onset indicator;
a frequency offset corrector arranged to correct a frequency offset of the received signal within the burst of the input signal based on the onset indicator, to provide a frequency offset corrected signal; and
means arranged to detect timing of first symbol of a first frame of the frequency offset corrected signal, to provide a timing indicator.

2. An apparatus according to claim 1, wherein the preamble sequence of the input signal is a pseudonoise sequence.

3. An apparatus according to claim 2, further comprising an equalizer arranged to remove inter-symbol interference from the frequency offset corrected signal based on the timing indicator.

4. An apparatus according to claim 3, wherein said means arrange to detect timing obtains a channel estimation to provide fast convergence in the equalizer.

5. An apparatus according to claim 2, wherein said means arranged to detect an onset of a burst comprises:
preamble storage for storing a reference preamble sequence;
a correlator for correlating the input signal with the reference preamble sequence from the preamble storage, to provide a correlation value;
a comparator arranged to compare the correlation value with a predetermined threshold and enable a slope detector when the correlation value is larger than the threshold; and
wherein the slope detector is arranged to detect slope of the correlation values, determine the onset of the burst of the input signal and output the onset indicator.

6. An apparatus according to claim 5, wherein, if |rₚₚ(i−1)|<|rₚₚ(i)|<|rₚₚ(i+1)|<|rₚₚ(I+2)|, and |rₚₚ(i−1)| is smaller than the threshold, and |rₚₚ(i)|, |rₚₚ(i+1)| and |rₚₚ(i+2)| are larger than the threshold, then said slope detector output the onset indicator, where, |rₚₚ(i−1)|, |rₚₚ(i)|, |rₚₚ(i+1)| and |rₚₚ(i+2)| are correlation values at timing i−1, i, i+1 and i+2, respectively.

7. An apparatus according to claim 6, the onset indicator is timing i+2.

8. An apparatus according to claim 2, wherein said means arranged to detect timing further comprises:
preamble storage arranged to store a reference preamble sequence;
a correlator for correlating the input signal with the reference preamble sequence from the preamble storage, to provide a correlation value;
sliding Window arranged to store a certain number of the correlation values; and
a peak searcher for finding the largest correlation value within the sliding window and output the timing indicator.

9. An apparatus according to claim 8, wherein the timing indicator is the timing of the largest correlation value.

10. An apparatus according to claim 8, wherein the peak searcher further obtains the channel estimation and outputs the channel estimation to the equalizer.

11. An apparatus according to claim 8., wherein length of the sliding window is shorter than length of one preamble.

12. An apparatus according to claim 8, wherein the starting point of the sliding window is the onset indicator.

13. An apparatus according to claim 3, further comprising a differential demodulator for demodulating the output signal from the equalizer based on the timing indicator.

14. An apparatus according to claim 13, wherein the equalizer is a fractionally spaced adaptive DFE equalizer.

15. An apparatus according to claim 14, wherein the equalizer comprises a feedforward filter, a feedback filter, a first subtractor, a decider, a coefficient calculator and a second subtractor, wherein,
in a training mode, the feedforward filter processes the frequency offset corrected signal and forwards its processed signals to the first subtractor, the feedback filter processes a reference symbol sequence and provides its processed signals to the first subtractor, the first subtractor subtracts the processed signals of the feedback filter from those of the feedback filter and outputs a first difference to the decider; the decider compares the first different with a predetermined threshold and output a decision signal, the second subtractor subtracts the first difference from the decision signal and output a second difference to the coefficient calculator, the coefficient calculator calculates the coefficients of the feedforward filter and feedback filter according to the channel estimation from the timing detecting means and the second difference from the second subtractor; and
in a tracking mode, the feedforward filter processes the frequency offset corrected signal and forwards its processed signals to the first subtractor, the feedback filter processes the decision signal from the decider and provides its processed signals to the first subtractor, the first subtractor subtracts the processed signals of the feedback filter from those of the feedforward filter and outputs the first difference to the decider; the decider compares the first difference with a predetermined threshold and outputs the decision signal to the feedback filter.

16. An apparatus according to claim 15, wherein in the training mode, the differential demodulator is switched: off, while in the tracking mode the coefficients of the filters are frozen and the differential demodulator demodulates the first difference from the first subtractor of the equalizer.

17. An apparatus according to claim 15, wherein the coefficient calculator applies a complex LMS algorithm to calculate the coefficients of the filters.

18. A digital receiver, comprising:
means arranged to convert a received signal into a baseband digital signal;
means arranged to detect an onset of a burst of the input signal to provide an onset indicator;
a frequency offset corrector arranged to correct a frequency offset of the received signal within the burst of the input signal based on the onset indicator, to provide a frequency offset corrected signal; and
means arranged to detect timing-of first symbol of first frame of the frequency offset corrected signal, to provide a timing indicator;
an equalizer arranged to remove inter-symbol interference from the frequency offset corrected signal based on the timing indicator; and
a differential demodulator, integrated with the equalizer, arranged to differential demodulate the output from the equalizer based on the timing indicator.

19. A digital receiver according to claim 18, wherein the preamble sequence of the baseband digital signal is a pseudonoise sequence.

20. A digital receiver according to claim 18, wherein said means arrange to detect timing is further arranged to obtain a channel estimation to assist the equalizer converge fast.

21. A digital receiver according to claim 18, wherein the means arranged to convert further comprises:
a frequency converter arranged to convert frequency of the received signal from RF/IF into baseband, to provide a baseband analog signal;
an A/D converter arranged to analog-to-digital convert the baseband analog signal into a baseband digital signal; and
a matched filter arranged to filter the baseband digital signal.

22. A method of burst and timing synchronization of an input signal in high-rate indoor wireless communication, comprising:
detecting onset of a burst of the input signal to provide an onset indicator;
correcting a frequency offset of the received signal within the burst of the input signal based on the onset indicator, to provide a frequency offset corrected signal; and
detecting timing of first symbol of first frame of the frequency offset corrected signal, to provide a timing indicator.

23. A method according to claim 22, wherein the preamble sequence of the input signal is a pseudonoise sequence.

24. A method according to claim 23, wherein further comprising a step of removing inter-symbol interference from the frequency offset corrected signal based on the timing indicator.

25. A method according to claim 24, wherein the step of detecting timing further comprises a step of obtaining a channel estimation at the same time as the timing detection of the first symbol of the first frame.
